(19) United States
(12) Patent Application Publication
(10) Pub. No.: US 2026/0291547 A1
(43) Pub. Date: Sep. 24, 2026

(54) ADAPTATION OF ANTENNA WEIGHTS FOR D-MIMO COMMUNICATION OF MULTI-ANTENNA DEVICES

(71) Applicant: Telefonaktiebolaget LM Ericsson (publ), Stockholm (SE)

(72) Inventors: Hiroki IIMORI, Yokohama-shi, Kanagawa (JP); Jörg HUSCHKE, KÖLN (DE)

(73) Assignee: Telefonaktiebolaget LM Ericsson (publ), Stockholm (SE)

(21) Appl. No.: 19/472,712

(22) PCT Filed: Apr. 7, 2023
(86) PCT No.: PCT/EP2023/059322

§ 371 Date: Oct. 6, 2025

(51) Int. Cl. H04B 7/024; H04B 7/06

(52) U.S. Cl. CPC H04B 7/024; H04B 7/0617

(57) ABSTRACT

A wireless communication network is equipped with a plurality of multi-antenna access points (101, 102, 103, 104, 105, 106, 107, 108, 109) and a plurality of multi-antenna wireless devices (11, 12, 13, 14) communicating with the multi-antenna access points (101, 102, 103, 104, 105, 106, 107, 108, 109) via a wireless channel. According to the method, channel state information of the wireless channel is obtained. Based on the channel state information, antenna weights for each of the access points (101, 102, 103, 104, 105, 106, 107, 108, 109) and antenna weights for each of the wireless devices are determined. Based on the antenna weights determined for the wireless devices (11, 12, 13, 14), the antenna weights of the access points (101, 102, 103, 104, 105, 106, 107, 108, 109) are updated. Based on the antenna weights determined for the access points (101, 102, 103, 104, 105, 106, 107, 108, 109), the antenna weights of the wireless devices (11, 12, 13, 14) are updated.

### TECHNICAL FIELD

The present invention relates to methods for controlling wireless transmissions and to corresponding devices, systems, and computer programs.

### BACKGROUND

In wireless communication networks, e.g., based on the 4G (4th Generation) LTE (Long Term Evolution) or 5G (5th Generation) NR technology as specified by 3GPP (3rd Generation Partnership Project), it is known to utilize MIMO (multiple input/multiple output) wireless transmissions to achieve improved capacity and/or performance. Such MIMO wireless transmissions are typically based on utilizing multiple antennas at an access node of the wireless communication network, in the LTE technology typically denoted as “eNB” (Evolved Node B”) and in the NR technology typically denoted as “gNB” (Next Generation Node B). Further, multiple antennas are typically also utilized at the UE (user equipment).

For further developments in future wireless systems such as fifth generation advanced (5G-A) and sixth generation (6G) systems, it is considered to introduce further enhancements based on distributed MIMO (D-MIMO) technology. Examples of such D-MIMO technologies are described in “Cell-free massive MIMO versus small cells”, by H. Q. Ngo, A. Ashikhmin, H. Yang, E. G. Larsson, and T. L. Marzetta, IEEE Trans. Wireless Commun., vol. 16, no. 3, pp. 1834-1850, 2017, in “Distributed antennas for indoor radio communications”, by A. Saleh, A. Rustako, and R. Roman, IEEE Trans. Commun., vol. 35, pp. 1245-1251, 1987, in “Coordinated multipoint transmission and reception in LTEadvanced: Deployment scenarios and operational challenges”, by D. Lee, H. Seo, B. Clerckx, E. Hardouin, D. Mazzarese, S. Nagata, and K. Sayana, IEEE Commun. Mag., vol. 50, no. 2, pp. 148-155, 2012], and in “Network MIMO: Overcoming intercell interference in indoor wireless systems”, by S. Venkatesan, A. Lozano, and R. Valenzuela, in Asilomar Conf. Sig., Sys. Comp., 2007.

A principle underlying D-MIMO technology is to distribute service antennas geographically and let them operate together. A typical architecture is that multiple antenna panels, sometimes also denoted as access points (APs), are interconnected and configured in such a way that they can cooperate in a phase-coherent manner. Each AP in turn may comprise multiple antenna elements that are also configured to cooperate in a phase-coherent manner. As a result, the combined antennas of all APs together effectively form a large, coherently operating antenna array. As compared to non-distributed MIMO setups), a link resulting from such spatial distribution of APs typically yields higher spatial degrees of freedom. Such degrees of freedom can be exploited in a number of ways. For example, they can be exploited to ensure fairer SNR (signal-to-noise ratio) distributions among user UEs, a larger number spatially multiplexed data streams, or higher link robustness.

It is envisioned that future D-MIMO deployments will provide an excess number of distributed APs, i.e. many more APs than active UEs. Further, it can be expected that each distributed AP will operate in a half-duplex mode. Still, such an excess number of half-duplex APs can effectively be utilized to realize a network yielding some of the advantages of full-duplex-like communications, without using real full-duplex hardware. For example, the network could provide benefits like low latency communication or high spectrum efficiency: If there is a large number of half-duplex APs distributed over a service area and each AP operates in either in downlink or uplink mode at the same time and frequency, this typically means that some APs will be receiving in the uplink (UL) and, at the same time and on the same frequency, other APs will be transmitting in the downlink (DL). Accordingly, even if individual APs operate in half-duplex mode, from a system-level perspective the communication has full-duplex characteristics.

The above-described a way of operating a D-MIMO network, and additional challenges resulting from it, has some resemblance with the dynamic time-division duplex (DTDD) technology of existing cellular systems, and in therefore is in the following also denoted as DTDD D-MIMO.

In the DTDD technology, UL and DL transmissions are dynamically switched depending on the UL and/or DL traffic demand of each cell. However, a problem resulting from such switching flexibility is that additional inter-cell cross-link interference may occur. Such inter-cell cross-link interference may include DL-to-UL interference, e.g., gNB-to-gNB interference and UL-to-DL interference, e.g., UE-to-UE interference). A similar type of cross-link interference may occur in DTDD D-MIMO. However, in this case there will be intra-cell cross-link interference in the form of AP-to-AP interference and UE-to-UE interference.

It is known to address cross-link interference problems in D-MIMO systems by means of linear filtering. Corresponding solutions are for example described in “Performance of network-assisted fullduplex for cell-free massive MIMO”, by D. Wang, M. Wang, P. Zhu, J. Li, J. Wang, and X. You, IEEE Trans. Commun., vol. 68, no. 3, pp. 1464-1478, 2020, in “Joint sparse beamforming and power control for a large-scale DAS with network-assisted full duplex”, by X. Xia, P. Zhu, J. Li, D. Wang, Y. Xin, and X. You, IEEE Trans. Veh. Technol., vol. 69, no. 7, pp. 7569-7582, 2020, and in “Joint access configuration and beamforming for cell-free massive MIMO systems with dynamic TDD”, by S. Fukue, H. Iimori, G. T. F. Abreu, and K. Ishibashi, IEEE Access, vol. 10, pp. 40130-40149, 2022. The aim of these existing solutions is to either maximize the system throughput performance or UE's fairness, which would result in uniform throughput among UEs. However, these known solutions all apply to scenarios where each UE is equipped with a only single antenna, which is not in line with many scenarios expected to be relevant in practice, where UEs will be equipped with multiple antennas.

Accordingly, there is a need for techniques which allow for efficiently controlling D-MIMO operation in scenarios involving multi-antenna wireless devices, e.g., UEs, in communication with multi-antenna access nodes, e.g., APs.

### SUMMARY

According to an embodiment, a method of controlling wireless transmissions in a wireless communication network is provided. The wireless communication network has a plurality of multi-antenna access points and a plurality of multi-antenna wireless devices communicating with the multi-antenna access points via a wireless channel. According to the method, channel state information (CSI) of the wireless channel is obtained. Based on the CSI, antenna weights for each of the access points and antenna weights for each of the wireless devices are determined. Based on the antenna weights determined for the wireless devices, the antenna weights of the access points are updated. Based on the antenna weights determined for the access points, the antenna weights of the wireless devices are updated.

According to a further embodiment, a node for a wireless communication network is provided. The wireless communication network has a plurality of multi-antenna access points and a plurality of multi-antenna wireless devices communicating with the multi-antenna access points via a wireless channel. The node is configured to obtain CSI of the wireless channel is obtained. Further, the node is configured to, based on the CSI, determine antenna weights for each of the access points and antenna weights for each of the wireless devices. Further, the node is configured to, based on the antenna weights determined for the wireless devices, update the antenna weights of the access points. Further, the node is configured to, based on the antenna weights determined for the access points, update the antenna weights of the wireless devices.

According to a further embodiment, a node for a wireless communication network is provided. The wireless communication network has a plurality of multi-antenna access points and a plurality of multi-antenna wireless devices communicating with the multi-antenna access points via a wireless channel. The node comprises at least one processor and a memory. The memory contains instructions executable by said at least one processor, whereby the node is operative to obtain CSI of the wireless channel is obtained. Further, the memory contains instructions executable by said at least one processor, whereby the node is operative to, based on the CSI, determine antenna weights for each of the access points and antenna weights for each of the wireless devices. Further, the memory contains instructions executable by said at least one processor, whereby the node is operative to, based on the antenna weights determined for the wireless devices, update the antenna weights of the access points. Further, the memory contains instructions executable by said at least one processor, whereby the node is operative to, based on the antenna weights determined for the access points, update the antenna weights of the wireless devices.

According to a further embodiment of the invention, a computer program or computer program product is provided, e.g., in the form of a non-transitory storage medium, which comprises program code to be executed by at least one processor of a node for a wireless communication network with a plurality of multi-antenna access points and a plurality of multi-antenna wireless devices communicating with the multi-antenna access points via a wireless channel. Execution of the program code causes the node to obtain CSI of the wireless channel is obtained. Further, execution of the program code causes the node to, based on the CSI, determine antenna weights for each of the access points and antenna weights for each of the wireless devices. Further, execution of the program code causes the node to, based on the antenna weights determined for the wireless devices, update the antenna weights of the access points. Further, execution of the program code causes the node to, based on the antenna weights determined for the access points, update the antenna weights of the wireless devices.

Details of such embodiments and further embodiments will be apparent from the following detailed description of embodiments.

### BRIEF DESCRIPTION OF THE DRAWINGS

FIG. 1 schematically illustrates a wireless communication network according to an embodiment.

FIG. 2 schematically illustrates an a D-MIMO setup according to an embodiment.

FIG. 3 schematically illustrates a procedure according to an embodiment.

FIG. 4 schematically further illustrates a further procedure according to an embodiment.

FIG. 5 schematically illustrates an iteration process according to an embodiment.

FIG. 6 shows a flowchart for schematically illustrating a method according to an embodiment.

FIG. 7 schematically illustrates structures of a network node according to an embodiment.

FIG. 8 schematically illustrates interaction of a host and a wireless device according to an embodiment.

### DETAILED DESCRIPTION

In the following, concepts in accordance with exemplary embodiments of the invention will be explained in more detail and with reference to the accompanying drawings. The illustrated embodiments relate to controlling of wireless communication in a wireless communication network, in particular for controlling MIMO wireless transmissions between access points and wireless devices (WDs). The wireless communication network may be based on the 5G NR technology specified by 3GPP. However, other technologies could be used as well, e.g., the 4G LTE technology specified by 3GPP or a future 6G (6th Generation) technology. The WD may correspond to various types of UEs or other types of WDs.

In the illustrated concepts, WDs, in the following denoted as UEs, may use DTDD D-MIMO operation in communication with access points of the wireless communication network. For this purpose, each of the access points is provided with multiple antennas. Similarly, the UEs are each provided with multiple antennas. For mitigating cross-link interference, linear filtering is utilized. The linear filtering is based on precoding of antenna signals to be transmitted on the wireless channel and on linear combining of antenna signals received from the wireless channel. For determining the antenna weights used in the precoding and the linear combining, a multi-stage process is used in which antenna weights of the access points are updated based on the antenna weights of the UEs and the antenna weights of the UEs are updated based on the antenna weights of the access points. Initial values of the antenna weights may be determined based on CSI. In some scenarios, the updating may be repeated in an iterative manner. The updating itself may be based on various methodologies, including for example maximum ratio based algorithms, minimum mean square error (MMSE) based algorithms, or combinations of such algorithms.

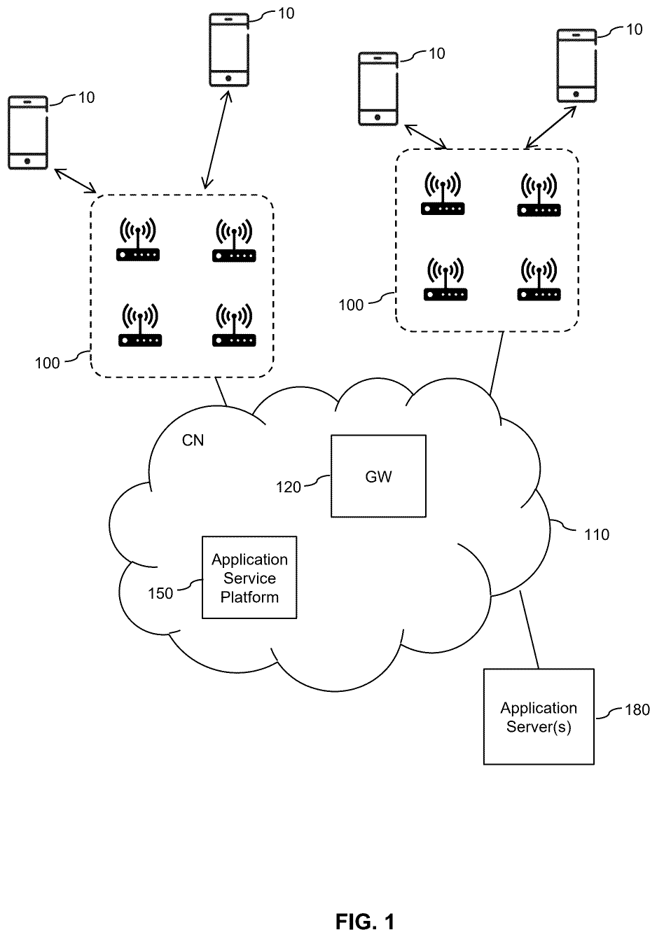

FIG. 1 illustrates exemplary structures of the wireless communication network. In particular, FIG. 1 shows UEs 10 which are served by access nodes 100 of the wireless communication network. Here, it is noted that the wireless communication network may actually include a plurality of access nodes 100 that may serve a number of cells within the coverage area of the wireless communication network. As further illustrated, the access nodes 100 are each implemented based on a set of distributed APs, which may be used in a DTDD D-MIMO setup, e.g., as further detailed below.

The access nodes 100 may be regarded as being part of an RAN of the wireless communication network. Further, FIG. 1 schematically illustrates a CN (Core Network) 110 of the wireless communication network. In FIG. 1, the CN 110 is illustrated as including a GW (gateway) 120 and one or more control node(s) 140. The GW 120 may be responsible for handling user plane data traffic of the UEs 10, e.g., by forwarding user plane data traffic from a UE 10 to a network destination or by forwarding user plane data traffic from a network source to a UE 10. Here, the network destination may correspond to another UE 10, to an internal node of the wireless communication network, or to an external node which is connected to the wireless communication network. Similarly, the network source may correspond to another UE 10, to an internal node of the wireless communication network, or to an external node which is connected to the wireless communication network. The GW may for example correspond to a UPF (User Plane Function) of the 5G Core (EGC) or to an SGW (Serving Gateway) or PGW (Packet Data Gateway) of the 4G EPC (Evolved Packet Core). The control node(s) 140 may be used for controlling the user data traffic, e.g., by providing control data to the access node 100, the GW 120, and/or to the UE 10.

As illustrated by solid double-headed arrows, the access node 100 may send DL wireless transmissions to at least some of the UEs 10, and some of the UEs 10 may send UL wireless transmissions to the access node 100.

The DL transmissions and UL transmissions may be used to provide various kinds of services to the UEs 10, e.g., a voice service, a multimedia service, or some other data service. Such services may be hosted in the CN 110, e.g., by a corresponding network node. By way of example, FIG. 1 illustrates an application service platform 150 provided in the CN 110. Further, such services may be hosted externally, e.g., by an AF (application function) connected to the CN 110. By way of example, FIG. 1 illustrates one or more application servers 160 connected to the CN 110. The application server(s) 160 could for example connect through the Internet or some other wide area communication network to the CN 110. The application service platform 150 may be based on a server or a cloud computing system and be hosted by one or more host computers. Similarly, the application server(s) 160 may be based on a server or a cloud computing system and be hosted by one or more host computers. The application server(s) 160 may include or be associated with one or more AFs that enable interaction with the CN 110 to provide one or more services through the UEs 10 to the remote device 21, corresponding to one or more applications. These services or applications may generate the user data traffic conveyed by the DL transmissions and/or the UL transmissions between the access node 100 and the respective UE 10. Accordingly, the application server(s) 160 may include or correspond to the above-mentioned network destination and/or network source for the user data traffic. In the respective UE 10, such service may be based on an application (or shortly “app”) which is executed on the UE 10. Such application may be pre-installed or installed by the user. Such application may generate at least a part of the user plane data traffic between the UEs 10 and the access node 100.

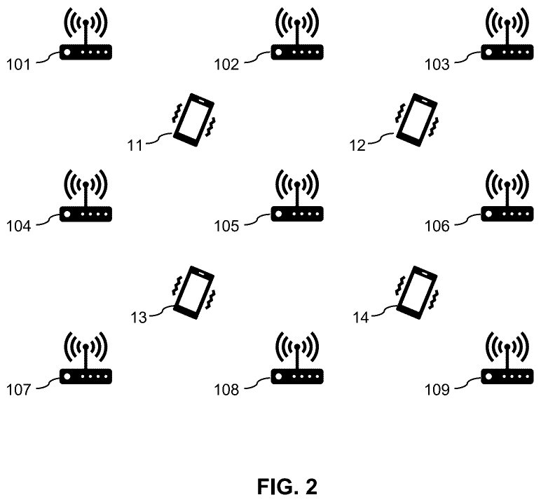

FIG. 2 further illustrates an example of a DTDD D-MIMO setup, e.g., as used in the above-mentioned access nodes 100. In the illustrated example, the DTDD D-MIMO setup includes APs 101, 102, 103, 104, 105, 106, 107, 108, 109 and UEs 11, 12, 13, 14. The DTDD operation of the setup may involve that the assignment of APs an UEs with UL transmissions and APs and UEs with DL transmissions varies over time. For example, in a given time slot the APs 101, 102, 104, 105, 109 and UEs 11 and 14 could operate in the UL, while the APs 103, 106, 107, and 108 and the UEs 12 and 13 in operate in the DL. In another time slot, the APs 101, 102, 104, 105, 109 and UEs 11 and 14 could operate in the DL, while the APs 103, 106, 107, and 108 and the UEs 12 and 13 in operate in the UL. Also the grouping of APs and UEs to operate either in the UL or in the DL may vary from time slot to time slot.

When considering a DTDD D-MIMO system serving multiple multi-antenna UEs on the same time-frequency resources, e.g., as illustrated in FIG. 2, it can for simplicity be assumed that each AP is equipped with M antennas and each UE is equipped with N antennas, and all APs and UEs operate in half-duplex mode. It is however noted that the following explanation can also be generalized to cases where the number of antennas differs between at least some of the APs and/or between at least some of the UEs. Information concerning the current UL and DL traffic demand of the UEs may also be available in the network and be used to decide which UE will operate in the UL and which UE will operate in the DL. Further, the illustrated concepts could also be applied in scenarios where at least some of the APs and/or of the UEs operate in a full-duplex mode. The APs may be connected to a common centralized processing unit (CPU), which may be responsible for the network-side signal processing. Such connection of the APs may for example be based on a fronthaul link.

For the processing of the antenna signals of UL transmissions and DL transmissions at the APs and at the UEs, linear filtering weights for the APs and the UEs are determined. Such linear filtering weights are herein also referred to as antenna weights. Since each AP is assumed to be only capable of half-duplex communications, an AP assigned to the UL group may not transmit in the DL simultaneously, and vice versa. The linear filtering weights thus include (A) precoding weights for DL APs and UL UEs and (B) combining weights for UL APs and DL UEs. In the following, APs transmitting DL signals to UEs are also referred to as DL APs, while APs receiving UL signals from UEs are referred to as UL APs. Similarly, UEs receiving DL signals from APs are referred to as DL UEs, while UEs transmitting UL signals to APs are referred to as UL UEs. In the following, [symbol] denotes the set of UL APs, and [symbol] denotes the set of DL APs. Similarly, [symbol] denotes the set of UL UEs, and [symbol] denotes the set of DL UEs.

As mentioned above, the DTDD D-MIMO system may suffer from cross-link interference. The cross-link interference typically includes interference from DL APs to UL APs, and interference from UL UEs to DL UEs, because UL transmissions and DL transmissions occur simultaneously and on the same frequency resources.

The received UL signal from the kᵤ-th UL UE (with kᵤ∈ [symbol] ) is interfered by the DL signals from other DL APs, which can be expressed as follows:

$${\hat{s}}_{{k}_{u}} = ( {\sum }_{l = 1}^{{ℒ}_{u}} {ν}_{{k}_{u} l}^{H} {H}_{{k}_{u} l} {f}_{{k}_{u}} ) {s}_{{k}_{u}} + {\sum }_{i = 1 , i \neq {k}_{u}}^{{𝒦}_{u}} ( {\sum }_{l = 1}^{{ℒ}_{u}} {ν}_{{k}_{u} l}^{H} {H}_{il} {f}_{i} ) {s}_{i} + {\underbrace{{\sum }_{l = 1}^{{ℒ}_{u}} {ν}_{{k}_{u} l}^{H} ( {\sum }_{{l}^{′} = 1}^{{ℒ}_{d}} {\ddot{H}}_{l {l}^{′}} ( {\sum }_{{k}^{′} = 1}^{{𝒦}_{d}} {w}_{{k}^{′} {l}^{′}} {x}_{{k}^{′}} ) )}}_{Interference from DL APs to UL APs} + \text{?}$$

$$\text{?} \text{indicates text missing or illegible when filed}$$

where

$${ν}_{k l}^{H} ∈ {ℂ}^{1 \times M}$$

is the combining vector at the l-th AP with l∈ [symbol] to detect signal from the kᵤ-th UL UE; Hₖₗ∈ [symbol] denotes the channel matrix between k-th UE and l-th AP; fₖ_{ᵤ}∈ [symbol] is the precoding vector at kᵤ-th UL UE; \ddot{H}_{ll′}∈ [symbol] is the cross-AP channel matrix between l-th UL AP and l′-th DL AP; w_{k′l′} denotes the precoding vector at l′-th DL AP towards k′-th DL UE; nₗ is the noise vector at l-th UL AP.

Similarly, the received signal at ka-th DL UE (with k_{d}∈ [symbol] ) can be expressed as

$${\hat{x}}_{{k}_{d}} = {g}_{{k}_{d}}^{H} ( {\sum }_{l = 1}^{{ℒ}_{d}} {H}_{{k}_{d} l}^{T} {w}_{{k}_{d} l} {x}_{{k}_{d}} + {\sum }_{l = 1}^{{ℒ}_{d}} {H}_{{k}_{d} l}^{T} {\sum }_{i = 1 , i \neq k}^{{𝒦}_{d}} {w}_{i l} {x}_{i} + {{\underbrace{{\sum }_{{k}^{′} = 1}^{{𝒦}_{u}} {\dot{H}}_{{k}_{d} {k}^{′}} {f}_{{k}^{′}} {s}_{{k}^{′}}}}_{Interference from UL UEs}}_{to DL UEs} + {n}_{{k}_{d}} ) \qquad ( 2 )$$

where

$${g}_{{k}_{d}}^{H}$$

is the combining vector at k_{d}-th DL UE, nₖ_{_{d}} is the noise vector at ka-th DL UE, the channel UL-DL reciprocity is assumed, and \dot{H}ₖ_{_{d}}_{k′} is the interference channel matrix from the k′-th uplink UE to ka-th DL UE.

As shown in equations (1) and (2), the precoding vectors (i.e., fₖ_{ᵤ} and wₖ_{_{d}}ₗ) are linearly multiplied with the combining vectors

$$( i . e . , {ν}_{{k}_{u} l}^{H} and {g}_{{k}_{d}}^{H} ) ,$$

resulting in the fact that an optimal solution for one is often a function of the others. In other words, they are dependent on each other, which may be referred to as “variable coupling”. This variable coupling would not happen in cases where each UE is equipped with only a single antenna. However, in the case of multi-antenna UEs, the variable coupling makes the determination of the linear filtering weights is a complex task. In the illustrated concepts such complexity is addressed by a multi-stage updating process in which the linear filtering weights of the APs and the linear filtering weights of the UEs, i.e.,

$${f}_{{k}_{u}} , {w}_{{k}_{d} l} , {ν}_{{k}_{u} l}^{H} , and {g}_{{k}_{d}}^{H} ,$$

are updated in an alternating manner.

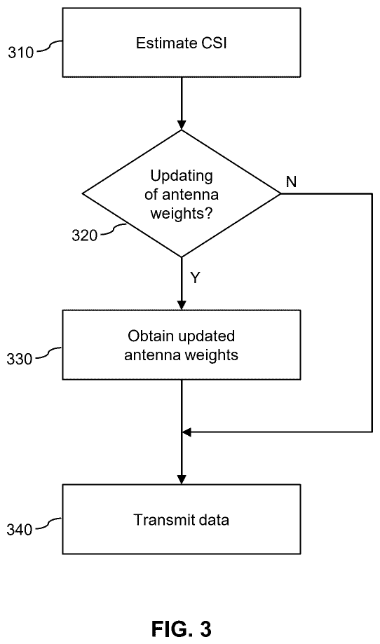

FIG. 3 shows a flowchart for illustrating an example of a linear filtering update process in accordance with the illustrated concepts.

In the process of FIG. 3, CSI for the wireless channel between the UEs and the APs is estimated at block 310, e.g., in terms of estimates for the coefficients Hₖₗ of the above-mentioned channel matrix, cross-AP channel matrix \ddot{H}_{ll′}, and interference channel matrix \dot{H}ₖ_{_{d}}_{k′}.

At block 320, it is decided whether updating of the antenna weights is needed. If this is the case, as indicated by branch “Y”, the process continues to block 330, where updated antenna weights are obtained.

At block 340, DTDD D-MIMO wireless transmissions are performed based on the antenna weights. Here, UL transmissions from some of the UEs to some of the APs are performed simultaneously with DL transmissions from other APs to other UEs.

If at block 320 it is found that no updating of the antenna weights is needed, as indicated by branch “N”, the process may also directly proceed to block 340, without the obtaining of updated antenna weights at block 330.

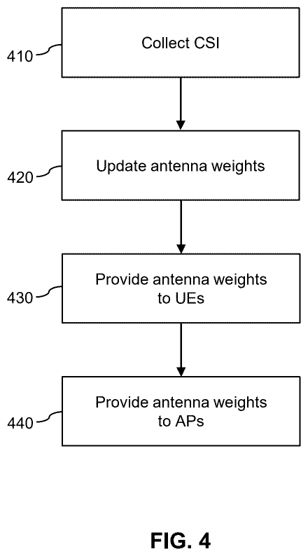

FIG. 4 shows a flowchart for illustrating an example of a multi-stage update process in accordance with the illustrated concepts, including the multi-stage updates at the CPU, and feedback of antenna weights to the UEs and to the APs.

At block 410, the CPU collects CSI for the wireless channel between the UEs and the APs is collected at block 410. This may involve receiving CSI reports from the APs and/or from the UEs.

At block 420, the CPU uses the CSI as input to determine initial values of the antenna weights for the APs and initial values of the antenna weights for the UEs. Based on the initial values of the antenna weights for the UEs, the CPU updates the antenna weights for the APs. Based on the antenna weights for the APs, the CPU updates the antenna weights for the UEs. Such updates may be repeated in an iterative manner.

At block 430 the CPU provides the updated antenna weights to the UEs, and at block 440 the CPU provides the updated antenna weights to the APs.

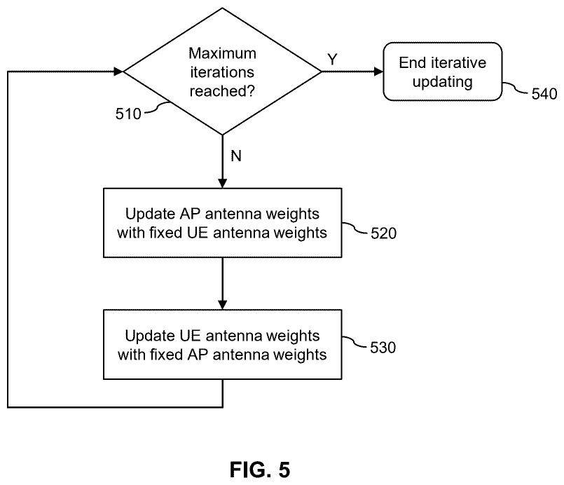

FIG. 5 shows a flowchart for illustrating a further example of an iterative process in accordance with the illustrated concepts, which may be used to optimize the antenna weights for the APs and the antenna weights for the UEs. The iterative update process of FIG. 5 may for example be used to obtain the updated antenna weights at block 330 in the process of FIG. 3 or at block 420 in the process of FIG. 4.

At block 510, it is checked if a maximum number of iterations is reached. If this is not the case, as indicated by branch “N”, the process continues to block 520.

At block 520, the antenna weights for the APs are updated based on the antenna weights for the UEs. This may in particular involve applying an optimization algorithm in which the antenna weights for the UEs are kept fixed. The process then continues to block 530.

At block 530, the antenna weights for the UEs are updated based on the antenna weights for the APs. This may in particular involve applying an optimization algorithm in which the antenna weights for the APs are kept fixed. The process then returns to block 510 to check if a further iteration is needed.

If the check of block 510 reveals that the maximum number of iterations is reached, as indicated by branch “Y”, the iterative updating is terminated, as indicated by block 540.

In the example of FIG. 5, a maximum number of iterations may be pre-determined according to the latency requirement and channel coherence time. Alternatively or in addition, the iterations could be terminated if the last update did not result in any major change of the antenna weights, e.g., if the difference of the antenna weights to their value before the update is below a threshold.

In the following methodologies which may be used for the updating of the antenna weights, e.g., as part of the processes in block 420 of FIG. 4 or in blocks 520 and 530 of FIG. 5, will be described in more detail by referring to exemplary update rules, each addressing different aspects and requirements. Which of these rules is applied may depend on requirements, such as latency requirements and/or throughput requirements.

A first approach for adaptation of the antenna weights is based on the singular value decomposition of the UE-AP channel, utilizing the dominant singular vectors. In other words, when assuming that LeftSV(⋅) is a function that outputs the left dominant singular vector of an input matrix, and RightSV(⋅) is a function that outputs the right dominant singular vector of the input matrix, the precoding and combining vectors can be written as:

$${ν}_{{k}_{u} l} = LeftSV ( {H}_{{k}_{u} l} )$$

$${f}_{{k}_{u}} = \sqrt{{ρ}_{UE , {k}_{u}}} \cdot {RightSV ( {H}_{{k}_{u} l} )}^{H}$$

$${g}_{{k}_{d}} = LeftSV ( {H}_{{k}_{d} , DL}^{T} )$$

$${w}_{{k}_{d} l} = \sqrt{{ρ}_{AP , {k}_{d} l}} \cdot {RightSV ( {H}_{{k}_{d} l}^{T} )}^{H}$$

where gₖ_{_{d}} is designed to be the left dominant singular vector of the concatenated matrix

$${H}_{k , DL}^{T} {=}^{Δ} [ {H}_{{k}_{d} {l}_{d , 1}}^{T} , … , {H}_{{k}_{d} {l}_{d , \vert {ℒ}_{d} \vert}}^{T} ]$$

consisting of the channel matrices between the k_{d}-th DL UE and DL APs with l_{d}∈ [symbol] , and ρ_{UE,k}_{ᵤ} and ρ_{AP,k}_{_{d}}ₗ denote the pre-scribed transmit power at the kᵤ-th UL UE and l-th AP towards ka-th DL UE, respectively (optionally, scaled by a scaling factor).

With this singular value decomposition approach, iterations are not needed, because additional iterations would not produce any changes in the antenna weights. Accordingly, the process of FIG. 5 could simply proceed to the block 540 after calculating the singular eigen pairs. It is noted that other singular vectors that have large singular values could be used if multi-layer transmission is considered.

A further approach is based on Maximum Ratio Transmission and Reception (MRTR). Such MRTR approach requires the CSI of only the UE-AP links and thus provides the benefit of a low communication overhead. On the other hand, in the MRTR approach, the cross-AP interference is not taken into consideration, which may cause degradation of system performance.

In case of MRTR, the precoding and combining vectors are designed to maximize the intended signal power, which is also known as conjugate beamforming design. As shown in equations (1) and (2), one can design this type of linear filtering as follows:

For a given initial filtering weights at either AP side or UE side, the antenna weights are alternatively updated, e.g., as illustrated by blocks 520 and 530 of FIG. 5. The updating of the antenna weights for the UEs aims at maximizing the intended signal power for fixed AP antenna weights, and the updating of the antenna weights for the APs aims at maximizing the intended signal power for fixed UE antenna weights. Considering the case where initial AP antenna weights are provided, the UE antenna weights can be expressed as:

$${f}_{{k}_{u}} = \sqrt{{ρ}_{UE , {k}_{u}}} \frac{{( {Σ}_{l = 1}^{{ℒ}_{u}} {v}_{{k}_{u} l}^{H} {H}_{{k}_{u} l} )}^{H}}{\vert {( {Σ}_{l = 1}^{{ℒ}_{u}} {v}_{{k}_{u} l}^{H} {H}_{{k}_{u} l} )}^{H} \vert}$$

$${g}_{{k}_{d}} = {\sum }_{l = 1}^{{ℒ}_{d}} {H}_{{k}_{d} l}^{T} {w}_{{k}_{d} l}$$

Similarly, in case where initial UE antenna weights are provided, the UE antenna weights can be updated with the aim of maximizing the intended signal power for fixed UE antenna weights.

A further approach is based on Maximum Ratio Transmission and Minimum Mean Square Error (MMSE) Reception. This approach intends to let the receivers take the responsibility to cancel out the harmful cross-link interference while the transmitters are designed to maximize the intended signal power. As illustrated by blocks 520 and 530 of FIG. 5, first update the AP antenna weights are updated for fixed UEs' filtering weights. In particular, vₖ_{ᵤ}ₗ and wₖ_{_{d}}ₗ are updated for fixed fₖ_{ᵤ} and gₖ_{_{d}}.

The updating of vₖ_{ᵤ}ₗ and wₖ_{_{d}}ₗ can be expressed as follows:

$${v}_{k , UL} = {\overbrace{{( {H}_{k , UL} {f}_{k} {f}_{k}^{H} {H}_{k , UL}^{H} + {\sum }_{i \neq k}^{{𝒦}_{u}} {H}_{i , UL} {f}_{i} {f}_{i}^{H} {H}_{i , UL}^{H} + {\underbrace{{\sum }_{{k}^{′} = 1}^{{𝒦}_{d}} \ddot{H} {w}_{{k}^{′} , DL} {w}_{{k}^{′} , DL}^{H} {\ddot{H}}^{H}}}_{AP - AP Interference} + {σ}^{2} I )}^{- 1} {H}_{k , UL} {f}_{k}}}^{MMSE receiver at UL APs taking the AP - AP cross interference into consideration}$$

$${w}_{{k}_{d} l} = \sqrt{{ρ}_{AP , {k}_{d} l}} \frac{{( {g}_{{k}_{d}}^{H} {H}_{{k}_{d} l}^{T} )}^{H}}{\vert {( {g}_{{k}_{d}}^{H} {H}_{{k}_{d} l}^{T} )}^{H} \vert}$$

where the concatenated matrix

$${H}_{k , UL} {=}^{Δ} {[ {H}_{{k}_{u} {l}_{u}}^{T} , … , {H}_{{k}_{u} \vert {ℒ}_{u} \vert}^{T} ]}^{T}$$

consisting of the channel matrices between the kᵤ-th UL UE and UL APs with lᵤ∈ [symbol] , and the stacked combining vector v_{k,UL} is expressed as

$${v}_{k , UL} {=}^{Δ} {[ {v}_{{k}_{u} {l}_{u}}^{T} , … , {v}_{{k}_{u} \vert {ℒ}_{u} \vert}^{T} ]}^{T}$$

collecting the combining vectors vₖ_{ᵤ}ₗ of all UL APs with lᵤ∈ [symbol] . The transmit power β_{AP,k}_{_{d}}ₗ may be pre-determined and can correspond to the maximum transmit power or to an optimized transmit power provided by a power optimization method.

In the next step, the antenna weights for the UEs are updated for fixed AP antenna weights. In particular, fₖ_{ᵤ} and gₖ_{_{d}} are updated for fixed vₖ_{ᵤ}ₗ and wₖ_{_{d}}ₗ.

The updating of fₖ_{ᵤ} and gₖ_{_{d}}. can be expressed as follows:

$${g}_{k} = {\overbrace{{( {\sum }_{i = 1}^{{𝒦}_{d}} {H}_{k , DL}^{T} {{w}_{i , DL} ( {H}_{k , DL}^{T} {w}_{i , DL} )}^{H} + {\underbrace{{\sum }_{{k}^{′} = 1}^{{𝒦}_{u}} {\dot{H}}_{{kk}^{′}} {{f}_{{k}^{′}} ( {\dot{H}}_{{kk}^{′}} {f}_{{k}^{′}} )}^{H}}}_{UE - UE Interference} + {σ}^{2} I )}^{- 1} {\sum }_{l = 1}^{{ℒ}_{d}} {H}_{kl}^{T} {w}_{kl}}}^{MMSE receiver at DL UEs taking the UE - UE cross interference into consideration}$$

$${f}_{{k}_{u}} = \sqrt{{ρ}_{UE , {k}_{u}}} \frac{{( {Σ}_{l = 1}^{{ℒ}_{u}} {v}_{{k}_{u} l}^{H} {H}_{{k}_{u} l} )}^{H}}{\vert {( {Σ}_{l = 1}^{{ℒ}_{u}} {v}_{{k}_{u} l}^{H} {H}_{{k}_{u} l} )}^{H} \vert}$$

For determining the initial values of the AP antenna weights and the UE antenna weights, non-random initialization, random initialization, or codebook-based initialization. In the case of non-random initialization, the initial values of the antenna weights may be set to some prescribed constant values, e.g., to 1. In the case of random initialization, the initial values of the antenna weights are set in a random manner. The random process can be based on any complex random distribution, such as the complex circularly symmetric Gaussian distribution. In the case of codebook based initialization, the initial values of the antenna weights are chosen to be a codeword from a prescribed codebook, such that the intended signal power at the antenna edge, i.e., before processing through the radio-frequency chain, is maximized. Here, possible choices of the codebook are implementation dependent. Some examples of such codebooks are Type I and Type II codebooks of the 5G NR technology or the Discrete Fourier Transform (DFT) matrix.

A further approach is based on MMSE transmission and MMSE reception. In the case of MMSE transmission and MMSE reception, both precoding weights and combining weights are designed as an MMSE filter taking into account the cross-link interference. As explained for blocks 520 and 530 of FIG. 5, the AP antenna weights are updated for fixed UE antenna weights and the UE antenna weights are updated for fixed AP antenna weights.

The updating of the AP antenna weights can be expressed as follows:

$${v}_{k , UL} = {\overbrace{{( {H}_{k , UL} {f}_{k} {f}_{k}^{H} {H}_{k , UL}^{H} + {\sum }_{i \neq k}^{{𝒦}_{u}} {H}_{i , UL} {f}_{i} {f}_{i}^{H} {H}_{i , UL}^{H} + {\underbrace{{\sum }_{{k}^{′} = 1}^{{𝒦}_{d}} \ddot{H} {w}_{{k}^{′} , DL} {w}_{{k}^{′} , DL}^{H} {\ddot{H}}^{H}}}_{AP - AP Interference} + {σ}^{2} I )}^{- 1} {H}_{k , UL} {f}_{k}}}^{MMSE receiver at UL APs taking the AP - AP cross interference into consideration}$$

As for the precoding weights at DL APs, the MMSE weights can be computed by solving the following convex optimization problem:

$${min}_{{w}_{k , DL}} {\overbrace{{\sum }_{i ∈ {𝒦}_{u}} {\vert {v}_{i , UL}^{H} \ddot{H} {w}_{k , DL} \vert}^{2}}}^{AP - AP Interference} + {\sum }_{j ∈ {𝒦}_{d}} {\vert {g}_{j}^{H} {H}_{j , DL}^{T} {w}_{k , DL} \vert}^{2} - 2 Re \{ {g}_{k}^{H} {H}_{k , DL}^{T} {w}_{k , DL} \}$$

$$s . t . {w}_{k , DL} ∈ {𝒫}_{DL}$$

where the stacked precoding vector w_{k,DL} is given by

$${w}_{k , DL} {=}^{Δ} {[ {w}_{{k}_{d} {l}_{d}}^{T} , … , {ν}_{{k}_{d} \vert {ℒ}_{d} \vert}^{T} ]}^{T}$$

with l_{d}∈ [symbol] , and [symbol] denotes the transmit power constraint at APs, which may be determined according to the hardware and system configuration. For example, the power constraint can be that the power of the precoding vector w_{k,DL} is regulated by certain maximum limit

$${P}_{max}^{D L} ,$$

namely

$${‖ {w}_{k , DL} ‖}^{2} \leq {P}_{max}^{D L} .$$

In another example, each element of the precoding vector w_{k,DL} may have a certain limit. This may be relevant to a case where one would like to control the maximum power of each power amplifier (PA) of at different APs.

The above convex optimization is a simple quadratically-constrained quadratic program. Accordingly, a solution can be obtained via a standard convex optimization solver.

Regarding the updates of UE antenna weights, the combiner weights gₖ_{_{d}} at the k_{d}-th DL UE can be expressed as:

$${g}_{k} = {\overbrace{{( {\sum }_{i = 1}^{{𝒦}_{d}} {H}_{k , DL}^{T} {{w}_{i , DL} ( {H}_{k , DL}^{T} {w}_{i , DL} )}^{H} + {\underbrace{{\sum }_{{k}^{′} = 1}^{{𝒦}_{u}} {\dot{H}}_{{kk}^{′}} {{f}_{{k}^{′}} ( {\dot{H}}_{{kk}^{′}} {f}_{{k}^{′}} )}^{H}}}_{UE - UE Interference} + {σ}^{2} I )}^{- 1} {\sum }_{l = 1}^{{ℒ}_{d}} {H}_{kl}^{T} {w}_{kl}}}^{MMSE receiver at DL UEs taking the UE - UE cross interference into consideration}$$

The MMSE precoding weights taking into account the cross-UE interference can be obtained by solving the following optimization problem

$${min}_{{f}_{k}} {\sum }_{i ∈ {𝒦}_{u}} {\vert {v}_{i}^{H} {H}_{k} {f}_{k} \vert}^{2} - 2 Re \{ {v}_{k}^{H} {H}_{k} {f}_{k} \} + {\overbrace{{\sum }_{j ∈ {𝒦}_{d}} {\vert {g}_{j}^{H} {\dot{H}}_{jk} {f}_{k} \vert}^{2}}}^{Cross - UE Interference}$$

$$s . t . {f}_{k} ∈ {𝒫}_{UL}$$

where [symbol] denotes the transmit power constraint at the UL UEs, which can be determined similarly to the transmit power constraint at APs [symbol] .

In some variants of the above approaches, the precoding weights wₖ_{_{d}}ₗ and fₖ_{ᵤ} can be computed by assuming uplink and downlink duality. In other words, the precoding weights wₖ_{_{d}}ₗ at DL APs can be computed similarly to the combining weights v_{k,UL} at UL APs, with the difference that DL UEs are considered as “virtual” UL UEs, while DL APs are assumed to receive signals from DL UEs. In turn, the precoding weights fₖ_{ᵤ} at UL UEs can also be computed similarly to the combining weights gₖ at DL UEs, with the difference that UL UEs are now considered as “virtual” DL UEs, which are assumed considered to receive signals from UL APs.

The effective SINR (Signal-to-Noise and Interference) performance of TDD (Time Division Duplex) and DTDD in D-MIMO systems with different filtering approaches was evaluated based on simulations. The effective SINR was computed by taking the SINR expression inside the logarithm of the Shannon capacity, i.e., SINR_{eff}=2^{R}−1, where R denotes the Shannon capacity R=τ log₂(1+SINR) with τ being the normalized time resource utilization factor and SINR is the actual SINR. The normalized time resource utilization factor was set to 1 when utilizing DTDD, as there is no TDD between UL and DL, while t was set to 0.5 when utilizing TDD, as the time resource is divided into two parts to operate in UL and DL separately. The transmit power was assumed to be 100 mW at UEs and 100 mW at APs. The data rate was calculated by the channel capacity formula with SINR formulations by equation (1) and (2). The path loss was modeled by the 3GPP Indoor Hotspot pathloss model (see, 3GPP TR 38.901 V14.0.0 InH—Office in Table 7.4.1-1 and LOS/NLOS probability according to Table 7.4.2-1), while the fading was modeled as a Rayleigh random variable. It was assumed that 16 APs are distributed in a square grid fashion, while 5 UEs are distributed randomly within a square service area with one-side length of 50 meter. In case of DTDD, the AP UL/DL configuration was determined such that the intended signal power from/to each UE is maximized in a long-term statistics sense while each UE has as equal number of APs assigned as possible. Further, the number of antennas at APs was assumed to be 4, and the number of antennas at UEs was assumed to be 2.

The following scenarios were compared: (1) A TDD scenario where the available time is divided into UL and DL in an equal manner, where the MRTR-based approach without cross-link interference is employed. (2) a TDD scenario where the available time is divided into UL and DL in an equal manner, where the Maximum Ratio Transmission and MMSE Reception approach without cross-link interference is employed. (3) A TDD scenario where the available time is divided into UL and DL in an equal manner, where the MMSE Transmission and MMSE Reception approach without cross-link interference is employed. (4) A DTDD scenario where the MRTR-based approach is employed. (5) A DTDD scenario where the Maximum Ratio Transmission and MMSE Reception approach is employed. (6) A DTDD scenario where the MMSE Transmission and MMSE Reception approach is employed. It was found that the DTDD in D-MIMO outperforms the TDD counterpart for a given filtering approach, thanks to the full-duplex-like transmission by allowing the joint UL/DL transmission. Furthermore, the MMSE designs at precoders and/or combiners are shown to be effective to cancel out the harmful cross-link interference while maximizing the intended signal power. When taking a look at UL and DL separately, it was found that for the UL the methodologies in accordance with the illustrated concepts can outperform the TDD counterpart. For the UL, the MMSE Transmission and MMSE Reception approach and the Maximum Ratio Transmission and MMSE Reception approach were found to be approximately equivalent to each other in the SINR performance. This can be attributed to the fact that as for the UL signals, the MMSE reception method was sufficient to cancel out the harmful interference thanks to plenty of spatial degrees of freedom, i.e., a large number of antennas at the APs. Therefore, the MMSE precoding trying to mitigate the effect of AP-AP interference was not necessarily required. In the case of the DL, it was however found that the MMSE combiners at DL UEs may not be able to sufficiently cancel out the UE-UE interference due to the lack of spatial degrees, which can be alleviated by the MMSE precoding trying to suppress the UE-UE interference. Further, it was found that the muti-stage update algorithms in accordance with the illustrated concepts converge within approximately 10 iterations. Accordingly, it may be useful to limit the number of iterations to a pre-determined maximum, taking into account the latency and performance requirements of the UEs.

In further simulations, also the duality-based approach was compared with the MRT-MMSE approach. It was found the duality-based approach can improve the worst-case performance as compared to the MRT-MMSE based approach. This can be attributed to the duality-based approach trying to equalize the achievable rate in UL and DL, which contributes to equalizing the capacity spread of among UEs. However, the MRT-MMSE approach can more often achieve a high data rate than the duality-based approach. Accordingly, in practice it may be beneficial to choose the approach depending on the UE and system needs and use case scenarios.

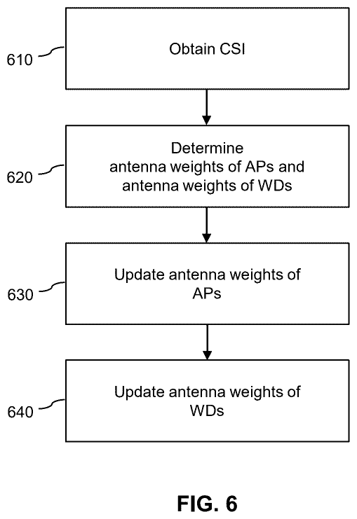

FIG. 6 shows a flowchart for illustrating a method, which may be utilized for implementing the illustrated concepts. The method of FIG. 6 may be used for implementing the illustrated concepts in a node of a wireless communication network. For example, the node may correspond to a CPU which is responsible for the signal processing of the above-mentioned APs. Such CPU could be implemented by one of the APs or by a separate node. As mentioned above, the method is applied in a scenario where wireless transmissions are performed on a wireless channel between with a plurality of multi-antenna APs and a plurality of multi-antenna wireless devices. The wireless devices may communicate with the multi-antenna APs in a half-duplex mode, with time resources for downlink communication from the APs to the wireless devices and time resources for UL communication from the wireless devices to the APs being assigned in a DTDD mode. That is to say, in different time slots, certain UEs and APs may be assigned to operate in UL, while other UEs and APs are assigned to operate in DL, and such assignment may vary in a dynamic manner from time slot to time slot, e.g., depending on a current demand for UL traffic and DL traffic. The wireless devices may for example correspond to UEs, such as the above-mentioned UEs 10, 11, 12, 13, 14.

If a processor-based implementation of the node is used, at least some of the steps of the method of FIG. 6 may be performed and/or controlled by one or more processors of the node. Such node may also include a memory storing program code for implementing at least some of the below described functionalities or steps of the method of FIG. 6.

At step 610, CSI of the wireless channel is obtained. This may for example involve receiving CSI reports from the wireless devices and/or from the APs. The CSI may relate to characteristics of the wireless channel between each antenna of the wireless devices and each antenna of the APs. In some scenarios, the CSI may additionally relate to cross-link interference between the APs and/or to cross-link interference between the wireless devices. In other words, the CSI may represent conditions of signal propagation between the wireless devices and the APs, conditions of signal propagation between the APs, and/or conditions of signal propagation between the wireless devices.

At step 620, antenna weights for each of the APs and antenna weights for each of the wireless devices are determined. This may be accomplished based on the CSI obtained at step 610. In some scenarios, step 620 may also involve random, non-random or codebook-based initialization of the antenna weights.

At step 630, the antenna weights determined for the APs, are updated based on the antenna weights determined for the APs. At step 640, the antenna weights determined for the wireless devices are updated based on the antenna weights determined for the APs. In some scenarios, the updating of step 630 may be performed first, and the updating of step 640 then be performed based on the updated antenna weights from step 630. Alternatively, the updating of step 640 may be performed first, and the updating of step 630 then be performed based on the updated antenna weights from step 640. The updating of the antenna weights for the APs and the updating of the antenna weights for the wireless devices may further be based on the CSI obtained at step 610.

In some scenarios, steps 630 and 640 may be repeated in an iterative manner. In such case,

the iterative updating could be terminated in response to the updating of the antenna weights for the APs and the updating of the antenna weights for the wireless devices causing changes of antenna weights below a threshold. Alternatively or in addition, the iterative updating could be terminated in response to a number of iterations of the iterative updating reaching a maximum limit of iterations. Such maximum limit of iterations could be 10 or smaller, more specifically 5 or smaller.

The updating of the antenna weights for the APs and the updating of the antenna weights for the wireless devices may be based on an optimization algorithm aiming at maximization of received signal power at the intended recipient. In some cases, the optimization algorithm may further aims at minimizing cross-link interference, in particular interference from APs operating in DL towards APs operating in UL, and/or interference from UEs operating in UL towards UEs operating in DL.

In some scenarios, step 630 may involve applying the optimization algorithm to update the antenna weights for the APs while keeping the antenna weights for the wireless devices constant. Similarly, step 640 may involve applying the optimization algorithm to update the antenna weights for the wireless devices while keeping the antenna weights for the APs constant.

In some cases, the optimization algorithm is based on an MRTR algorithm. Alternatively, the optimization algorithm could be based on an MRT and MMSE reception algorithm. Alternatively, the optimization algorithm could be based on an MMSE transmission and MMSE reception algorithm.

In some scenarios, the updating of the antenna weights for the APs and the updating of the antenna weights for the wireless devices is based on assuming UL-DL channel-reciprocity, herein also denoted as duality.

The antenna weights for the wireless devices may include precoding weights to be applied to UL wireless transmissions from the wireless devices. Further, the antenna weights for the wireless devices may include combining weights to be applied to DL wireless transmissions received by the wireless devices. The antenna weights for the APs may include precoding weights to be applied to DL wireless transmissions from the APs. Further, the antenna weights for the for the APs may include combining weights to be applied to uplink wireless transmissions received by the APs.

The updated antenna weights may then be provisioned to the wireless devices and to the APs.

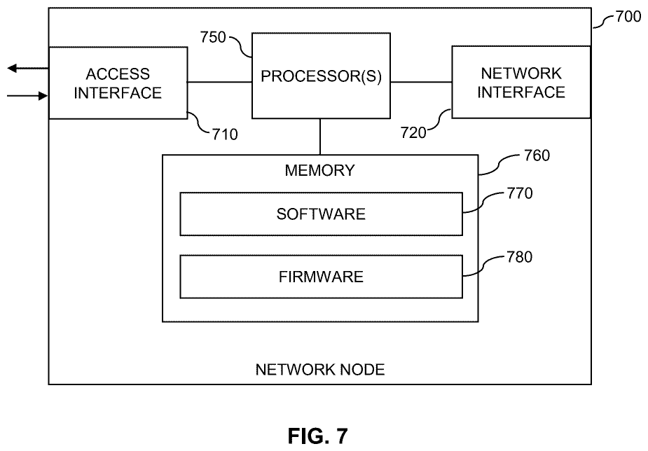

FIG. 7 illustrates a processor-based implementation of a node 700 for a wireless communication network, which may be used for implementing the above-described concepts. For example, the structures as illustrated in FIG. 7 may be used for implementing the concepts in a CPU which is responsible for the signal processing of the above-mentioned APs.

As illustrated, the node 700 may include one or more access interfaces 710. The access interface(s) 710 may for example be used for communicating with the APs. Further, the node 700 may include one or more network interfaces 720. The network interface(s) 720 may for example be used for communication with one or more other nodes of the wireless communication network, e.g., access nodes or CN nodes.

Further, the node 700 may include one or more processors 750 coupled to the interface(s) 710, 720 and a memory 760 coupled to the processor(s) 750. By way of example, the interface(s) 710, 720, the processor(s) 750, and the memory 760 could be coupled by one or more internal bus systems of the node 700. The memory 760 may include a read-only memory (ROM), e.g., a flash ROM, a random-access memory (RAM), e.g., a dynamic RAM (DRAM) or static RAM (SRAM), a mass storage, e.g., a hard disk or solid state disk, or the like. As illustrated, the memory 760 may include software 770 and/or firmware 780. The memory 760 may include suitably configured program code to be executed by the processor(s) 750 so as to implement or configure the above-described functionalities for controlling wireless communication based on multi-stage updating of antenna weights, such as explained in connection with FIG. 6.

It is to be understood that the structures as illustrated in FIG. 7 are merely schematic and that the node 700 may actually include further components which, for the sake of clarity, have not been illustrated, e.g., further interfaces or further processors. Also, it is to be understood that the memory 760 may include further program code for implementing known functionalities of a gNB in the NR technology or an eNB in the LTE technology. According to some embodiments, also a computer program may be provided for implementing functionalities of the node 700, e.g., in the form of a physical medium storing the program code and/or other data to be stored in the memory 760 or by making the program code available for download or by streaming.

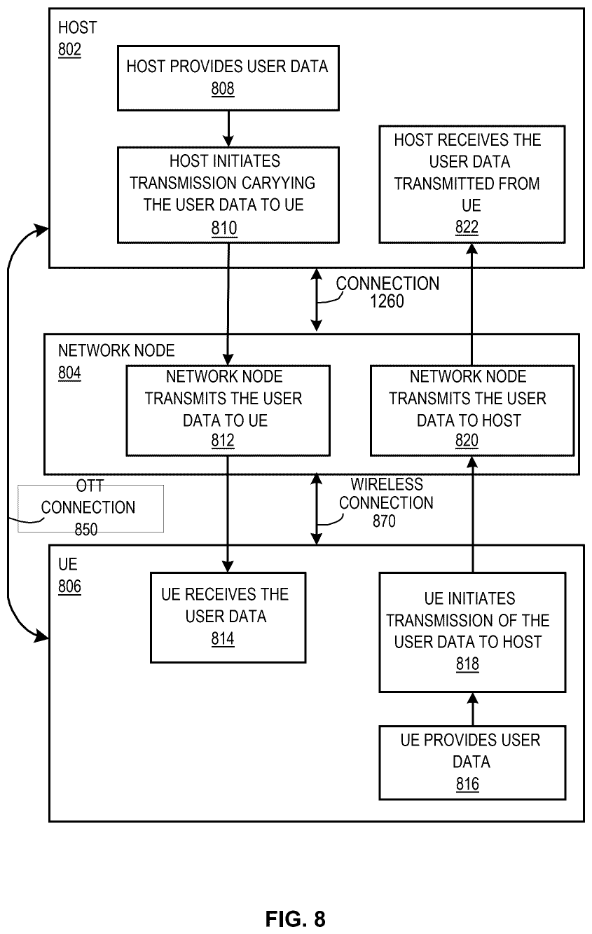

FIG. 8 shows a communication diagram of a host 802 communicating via a network node 804 with a UE 806 over a partially wireless connection in accordance with some embodiments. Example implementations, in accordance with various embodiments, of the UE (such as one of the above-mentioned UEs 10), network node (such as one of the above-mentioned base stations), and host (such as the above-mentioned service platform 150 or application server(s) 180) will now be described with reference to FIG. 8.

Embodiments of host 802 include hardware, such as a communication interface, processing circuitry, and memory. The host 802 also includes software, which is stored in or accessible by the host 802 and executable by the processing circuitry. The software includes a host application that may be operable to provide a service to a remote user, such as the UE 806 connecting via an over-the-top (OTT) connection 850 extending between the UE 806 and host 802. In providing the service to the remote user, a host application may provide user data which is transmitted using the OTT connection 850.

The network node 804 includes hardware enabling it to communicate with the host 802 and UE 806. The connection 860 may be direct or pass through a core network (like core network 110 of FIG. 4) and/or one or more other intermediate networks, such as one or more public, private, or hosted networks. For example, an intermediate network may be a backbone network or the Internet.

The UE 806 includes hardware and software, which is stored in or accessible by UE 806 and executable by the UE's processing circuitry. The software includes a client application, such as a web browser or operator-specific “app” that may be operable to provide a service to a human or non-human user via UE 806 with the support of the host 802. In the host 802, an executing host application may communicate with the executing client application via the OTT connection 850 terminating at the UE 806 and host 802. In providing the service to the user, the UE's client application may receive request data from the host's host application and provide user data in response to the request data. The OTT connection 850 may transfer both the request data and the user data. The UE's client application may interact with the user to generate the user data that it provides to the host application through the OTT connection 850.

The OTT connection 850 may extend via a connection 860 between the host 802 and the network node 804 and via a wireless connection 870 between the network node 804 and the UE 806 to provide the connection between the host 802 and the UE 806. The connection 860 and wireless connection 870, over which the OTT connection 850 may be provided, have been drawn abstractly to illustrate the communication between the host 802 and the UE 806 via the network node 804, without explicit reference to any intermediary devices and the precise routing of messages via these devices.

As an example of transmitting data via the OTT connection 850, in step 808, the host 802 provides user data, which may be performed by executing a host application. In some embodiments, the user data is associated with a particular human user interacting with the UE 806. In other embodiments, the user data is associated with a UE 806 that shares data with the host 802 without explicit human interaction. In step 810, the host 802 initiates a transmission carrying the user data towards the UE 806. The host 802 may initiate the transmission responsive to a request transmitted by the UE 806. The request may be caused by human interaction with the UE 806 or by operation of the client application executing on the UE 806. The transmission may pass via the network node 804, in accordance with the teachings of the embodiments described throughout this disclosure. Accordingly, in step 812, the network node 804 transmits to the UE 806 the user data that was carried in the transmission that the host 802 initiated, in accordance with the teachings of the embodiments described throughout this disclosure. In step 814, the UE 806 receives the user data carried in the transmission, which may be performed by a client application executed on the UE 806 associated with the host application executed by the host 802.

In some examples, the UE 806 executes a client application which provides user data to the host 802. The user data may be provided in reaction or response to the data received from the host 802. Accordingly, in step 816, the UE 806 may provide user data, which may be performed by executing the client application. In providing the user data, the client application may further consider user input received from the user via an input/output interface of the UE 806. Regardless of the specific manner in which the user data was provided, the UE 806 initiates, in step 818, transmission of the user data towards the host 802 via the network node 804. In step 820, in accordance with the teachings of the embodiments described throughout this disclosure, the network node 804 receives user data from the UE 806 and initiates transmission of the received user data towards the host 802. In step 822, the host 802 receives the user data carried in the transmission initiated by the UE 806.

The illustrated concepts may help to improve, performance of OTT services provided to the UE 806 using the OTT connection 850, in which the wireless connection 870 forms the last segment. More precisely, the teachings of these embodiments may improve the selection of appropriate antenna weights even in DTDD D-MIMO scenarios where UEs are equipped with multiple antennas. As a result, benefits of full-duplex like can be achieved for data transfers on the last segment of the OTT connection 850, even though the UE 806 and APs of the network node 804 operate only in half-duplex mode.

In an example scenario, factory status information may be collected and analyzed by the host 802. As another example, the host 802 may process audio and video data which may have been retrieved from a UE for use in creating maps. As another example, the host 802 may collect and analyze real-time data to assist in controlling vehicle congestion (e.g., controlling traffic lights). As another example, the host 802 may store surveillance video uploaded by a UE. As another example, the host 802 may store or control access to media content such as video, audio, VR or AR which it can broadcast, multicast or unicast to UEs. As other examples, the host 802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection 850 between the host 802 and UE 806, in response to variations in the measurement results. The measurement procedure and/or the network functionality for reconfiguring the OTT connection may be implemented in software and hardware of the host 802 and/or UE 806. In some embodiments, sensors (not shown) may be deployed in or in association with other devices through which the OTT connection 850 passes; the sensors may participate in the measurement procedure by supplying values of the monitored quantities exemplified above, or supplying values of other physical quantities from which software may compute or estimate the monitored quantities. The reconfiguring of the OTT connection 850 may include message format, retransmission settings, preferred routing etc.; the reconfiguring need not directly alter the operation of the network node 804. Such procedures and functionalities may be known and practiced in the art. In certain embodiments, measurements may involve proprietary UE signaling that facilitates measurements of throughput, propagation times, latency and the like, by the host 802. The measurements may be implemented in that software causes messages to be transmitted, in particular empty or ‘dummy’ messages, using the OTT connection 850 while monitoring propagation times, errors, etc.

As can be seen, the concepts as described above may be used for efficiently controlling wireless communication in DTDD D-MIMO setups where UEs are equipped with multiple antennas. Specifically, antenna weights can be determined in an efficient and precise manner, also taking into account variable coupling effects.

It is to be understood that the examples and embodiments as explained above are merely illustrative and susceptible to various modifications. For example, the illustrated concepts may be applied in connection with various kinds of wireless communication technologies. Further, the concepts may be applied with respect to various numbers of redundant connections. Moreover, it is to be understood that the above concepts may be implemented by using correspondingly designed software to be executed by one or more processors of an existing device or apparatus, or by using dedicated device hardware. Further, it should be noted that the illustrated apparatuses or devices may each be implemented as a single device or as a system of multiple interacting devices or modules.

1. A method of controlling wireless transmissions in a wireless communication network with a plurality of multi-antenna access points and a plurality of multi-antenna wireless devices communicating with the multi-antenna access points via a wireless channel in a half-duplex mode, with time resources for downlink communication from the access points to the wireless devices and time resources for uplink communication from the wireless devices to the access points being assigned in a dynamic time-division duplex mode, the method comprising:
obtaining channel state information, CSI, of the wireless channel;
based on the CSI, determining antenna weights for each of the access points and antenna weights for each of the wireless devices;
based on the antenna weights determined for the wireless devices, updating the antenna weights of the access points; and
based on the antenna weights determined for the access points, updating the antenna weights of the wireless devices.

2. The method according to claim 1, wherein the wireless devices communicate with the multi-antenna access points via the wireless channel in a half-duplex mode, with time resources for downlink communication from the access points to the wireless devices and time resources for uplink communication from the wireless devices to the access points being assigned in a dynamic time-division duplex mode.

3. The method according to claim 1, wherein the CSI represents conditions of signal propagation between the wireless devices and the access points, conditions of signal propagation between the access points, or conditions of signal propagation between the wireless devices.

4. The method according to claim 3, wherein the updating of the antenna weights for the access points and the updating of the antenna weights for the wireless devices is further based on the CSI.

5. The method according to claim 1, wherein the updating of the antenna weights for the access points and the updating of the antenna weights for the wireless devices is based on an optimization algorithm aiming at maximization of received signal power at the intended recipient.

6. The method according to claim 5, wherein the optimization algorithm further aims at minimizing cross-link interference.

7. The method according to claim 5, comprising:
applying the optimization algorithm to update the antenna weights for the access points while keeping the antenna weights for the wireless devices constant; and
applying the optimization algorithm to update the antenna weights for the wireless devices while keeping the antenna weights for the access points constant.

8. The method according to claim 5, wherein the optimization algorithm is based on a maximum ratio transmission and reception algorithm.

9. The method according to claim 5, wherein the optimization algorithm is based on a maximum ratio transmission and minimum-mean square error reception algorithm.

10. The method according to claim 5, wherein the optimization algorithm is based on a minimum-mean square error transmission and minimum-mean square error reception algorithm.

11. The method according to claim 1, wherein the updating of the antenna weights for the access points and the updating of the antenna weights for the wireless devices is performed in an iterative manner.

12. The method according to claim 11, comprising:
terminating the iterative updating in response to the updating of the antenna weights for the access points and the updating of the antenna weights for the wireless devices causing changes of antenna weights below a threshold.

13. The method according to claim 11, comprising:
terminating the iterative updating in response to a number of iterations of the iterative updating reaching a maximum limit of iterations.

14. The method according to claim 13, wherein the maximum limit of iterations is 10 or smaller.

15. The method according to claim 1, wherein the updating of the antenna weights for the access points and the updating of the antenna weights for the wireless devices is based on assuming uplink-downlink channel reciprocity.

16. The method according to claim 1, wherein the antenna weights for the wireless devices comprise precoding weights to be applied to uplink wireless transmissions from the wireless devices.

17. The method according to claim 1, wherein the antenna weights for the wireless devices comprise combining weights to be applied to downlink wireless transmissions received by the wireless devices.

18. The method according to claim 1, wherein the antenna weights for the access points comprise precoding weights to be applied to downlink wireless transmissions from the access points.

19. The method according to claim 1, wherein the antenna weights for the for the access points comprise combining weights to be applied to uplink wireless transmissions received by the access points.

20. A node for a wireless communication network with a plurality of multi-antenna access points and a plurality of multi-antenna wireless devices communicating with the multi-antenna access points via a wireless channel in a half-duplex mode, with time resources for downlink communication from the access points to the wireless devices and time resources for uplink communication from the wireless devices to the access points being assigned in a dynamic time-division duplex mode, the node being configured to:
obtain channel state information, CSI, of the wireless channel;
based on the CSI, determine antenna weights for each of the access points and antenna weights for each of the wireless devices;
based on the antenna weights determined for the wireless devices, update the antenna weights of the access points; and
based on the antenna weights determined for the access points, update the antenna weights of the wireless devices.

21-23. (canceled)
